(19) United States
(12) Patent Application Publication
(10) Pub. No.: US 2003/0222033 A1
(43) Pub. Date: Dec. 4, 2003

(54) Sanitation system

(76) Inventors: Paul L. Carroll II, Stuart, FL (US); Sterling L. Carroll, Palm City, FL (US)

Correspondence Address: Gregory A. Nelson, Esq., Akerman Senterfitt, 222 Lakeview Avenue, Ste. 400, P.O. Box 3188, West Palm Beach, FL, 33402-3188, US

(21) Appl. No.: 10/157,658

(22) Filed: May 29, 2002

(51) Int. Cl. B01D 24/02

(52) U.S. Cl. 210/805; 210/196; 210/532.2

(57) ABSTRACT

A filtration system for processing effluent from septic-based sanitation systems includes at least one treatment tank for receiving effluent from a septic tank. The tank includes filtering media therein, the filtering media adapted for filtering the effluent to produce filtered effluent. The system includes structure for recirculating the filtered effluent, wherein a first portion of the filtered effluent is directed back onto the filtering media and a second portion of the filtered effluent is directed out of said tank. The system can obviate the need for a drain field in septic-based sanitation systems.

### STATEMENT REGARDING FEDERALLY SPONSORED RESEARCH OR DEVELOPMENT

Not applicable.

### TECHNICAL FIELD

This invention relates to sanitation systems, and more particularly to septic-based sanitation systems.

### BACKGROUND OF THE INVENTION

Some conventional sanitation systems include a septic tank. Waste water from a home or small office first empties into the septic tank. Solids accumulate and decompose on the bottom of the tank and an effluent flows out from near the top of the tank into a drain field. The drain field, typically located a few feet below ground level, is intended to diffuse the effluent received from the tank into the soil, where suspended solids are filtered out and natural bacterial matter in the soil consumes the solids and other organisms as the effluent slowly leaches through the soil. The effluent eventually reaches the ground water in a substantially purified state.

The typical drain field comprises an effluent dispersal system including inclined conduits (e.g. PVC pipes) with holes at the bottom facing a stone bed. The stone bed provides a fluid flow path to the surrounding soil from the holes and prevents surrounding soil from filling the holes of the conduit.

Drain fields can become contaminated over time. Even relatively new drain fields can exhibit slow flow if the water table is too high, or the soil is highly compacted or otherwise has poor filtering and leaching qualities.

A drain field begins to deteriorate upon being placed in operation. Many factors not only shorten the useful life of drain field but reduce its ability to purify the effluent. The soil characteristics can change or might not be consistent. The water table may rise. Roots from trees can interfere with the leaching action. Certain substances in the effluent can interfere with bacterial action in the soil and speed the growth of slimy biological material at the soil interface that can eventually seal off the top of the drain field. This material is sometimes referred to as biomat.

When a drain field is contaminated, the effluent may no longer be absorbed at a sufficient rate to match the inflow rate of the effluent from the source, such as from a home. Thus, a back-up can occur, where a portion of the effluent will not be received by the septic tank for processing. For the homeowner, diverted effluent can flow into the home. For the environment, diverted effluent may not be properly cleansed by the sanitation system as a result of the back-up.

When a drain field is clogged, the repair is often complicated and expensive. The entire field must generally be dug up and a new trench of several hundred square feet is generally required.

Topographical conditions and recent more stringent governmental regulations can make it difficult or even impossible to install a new drain field. Septic systems are used only where building plots are large enough to provide the required drain field area for the expected effluent outflow from the home and can maintain proper spacing between the drain field and the domestic water well. Smaller plots can make it extremely difficult to layout drain fields, because a sizeable separation between the drain field and the well is generally mandated by local ordinances, such as 50 feet or more. In some instances, a lot of land will not be available for improvement due to insufficient spacing between the drain field and the well.

Sewer systems are expensive to install and generally do not return water in the effluent back to the surrounding environment, nor are the same generally available in many suburban communities. From an environmental perspective, a properly operating septic system is beneficial, because water consumed by a household is recycled. A typical home can consume a considerable amount of water each day, all of it ultimately entering the drain field. Most of this water eventually enters the water table filtered by the soil as it leaches downward.

However, even when configured on a given lot, septic systems generally have relatively short working lifetimes primarily because of deterioration of the drain field over the life of the field. Even properly operating septic systems can be periodically impaired by surrounding conditions, such as high water levels.

Some improved septic systems have been disclosed. For example, U.S. Pat. No. 6,238,563 to Carroll, II, which is assigned to the assignee of the present application, discloses an improved filtered septic-based sanitation system which can eliminate the need for a drain field. In the disclosed system, effluent from a septic tank is trickled through a first filter canister. The filtered effluent is recycled a plurality of times through the same filter canister to further cleanse the effluent. A small portion of the recycling effluent is directed outward into a drip irrigation system. A second filter canister, not in line with the first canister, also receives some of the recycled, filtered effluent, for plural recycles therethrough, to enhance the filtering process, at the same time that the remaining filtered effluent is being recycled through the first filter canister. The filtered effluent from the two canisters are permitted to combine prior to subsequent recycling.

### SUMMARY OF THE INVENTION

A filtration system for processing effluent from septic-based sanitation systems includes at least one treatment tank for receiving effluent from a septic tank. The tank includes filtering media therein, the filtering media adapted for filtering the effluent to produce filtered effluent. The filtering media can be in contact with the tank. The system includes structure for recirculating the filtered effluent, wherein a first portion of the filtered effluent is directed back onto the filtering media and a second portion of the filtered effluent is directed out of the tank. In some applications, the system can obviate the need for a drain field in septic-based sanitation systems.

The first portion which is recirculated for additional filtering can comprise at least 90% and preferably at least 95% of the filtered effluent. The structure for recirculating can include a submersible pump. The pump is preferably adapted to shut off when an effluent level is below a first predetermined level in the tank and turned on when the effluent level is above a second predetermined level in the tank. The pump and related components can be the only active component in the system. The pump is preferably raised above a bottom surface of the treatment tank.

At least one orifice plate can be used to divide the filtered effluent into the first and second portions. Spray heads can be used to distribute the first portion of filtered effluent substantially over the area defined by the top of the filter media.

The system can include a drip irrigation system, wherein the drip irrigation system receives the second portion of filtered effluent. The system can also include a chlorination tank for chlorinating the second portion. In certain application, the chlorinator is followed by a structure for dechlorinating the chlorinated second portion. A drip irrigation system can be supplied with liquid from the dechlorinated second portion.

A method of filtering effluent from septic-based sanitation systems includes the steps of directing effluent from a septic tank into at least one treatment tank, the treatment tank including at least one filtering media therein, the filtering media adapted for filtering the effluent to produce filtered effluent. The filtered effluent is at least partially recirculated, wherein a first portion of the filtered effluent is directed back onto the filtering media and a second portion of the filtered effluent is directed out of the tank.

### BRIEF DESCRIPTION OF THE DRAWINGS

A fuller understand of the present invention and the features and benefits thereof will be accomplished upon review of the following detailed description together with the accompanying drawings, in which:

FIG. 1 is a plan view of a home sanitation system, according to an embodiment of the invention.

FIG. 2 is a section along line A--A in FIG. 1.

FIG. 3 is a side view of a home sanitation system including a chlorinator, according to an embodiment of the invention.

### DETAILED DESCRIPTION OF THE PREFERRED EMBODIMENTS

The invention is an improved sanitation system for processing effluent supplied by a septic tank or equivalent. The sanitation system includes a simplified design, which can lower the cost improve the reliability as compared to conventional effluent treatment systems. In certain applications, the invention can be used to obviate the need for a drain field.

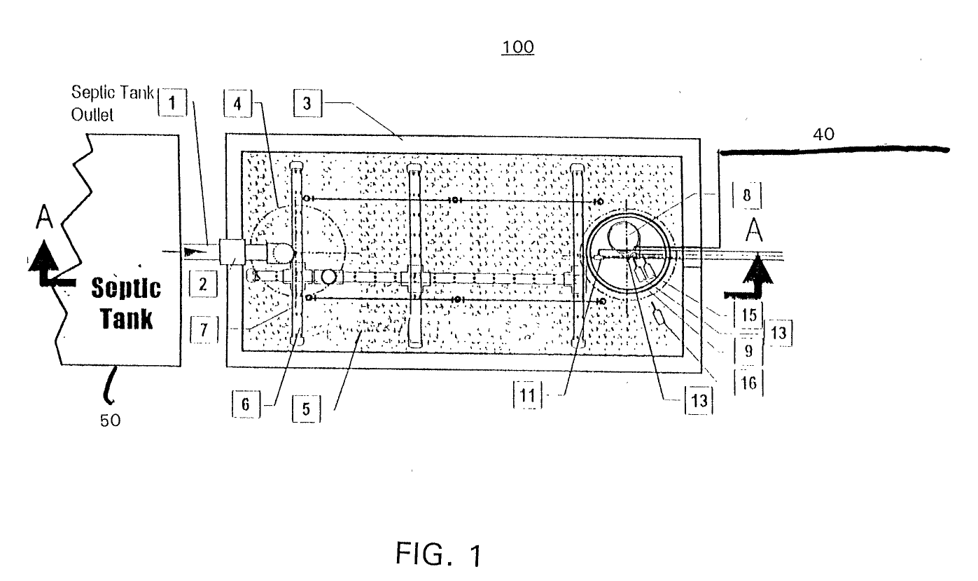

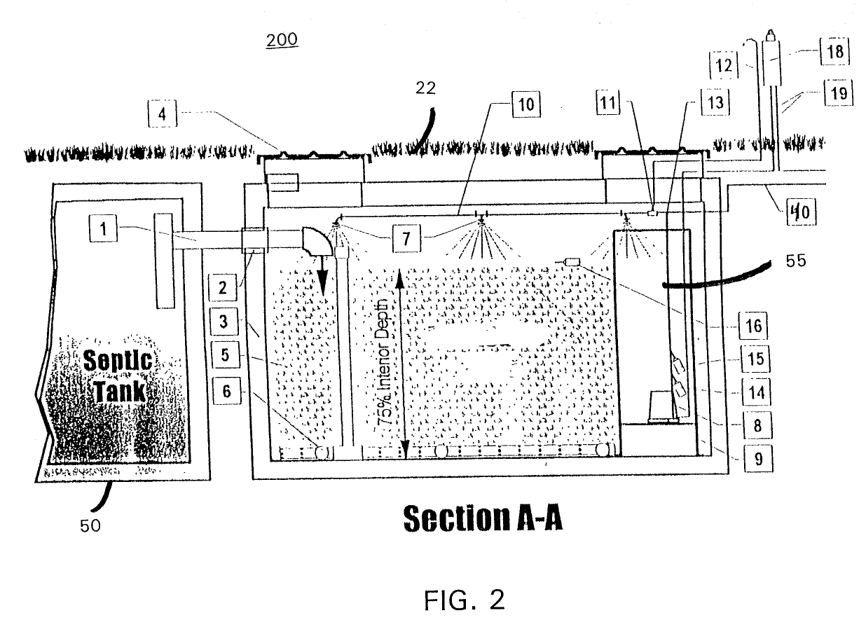

Referring to FIGS. 1 and 2, filtration system 100 is shown in a plan view and section view, respectively. Tank 3 receives effluent from a pipe 1, which is connected to the output of septic tank 50. Pipe 1 can be a PVC pipe, such as a 4 inch diameter pipe or other size. Septic tank 50 is generally connected to a home or commercial property (not shown). The entrance to tank 3 includes a substantially watertight seal 2 which enables pipe 1 to enter tank 3 in a sealed fashion. As shown in FIG. 2, tank 3 is buried in the ground and vegetation, such as grass 22, can cover the surface of the surrounding earth.

Tank 3 can be formed from any suitable material that can render the same sturdy and substantially water tight. Tank 3 preferably includes one or more removable lids 4, which can be sized to provide access therein, should servicing be required. Lids 4 may also be formed from any suitable material, the lid material preferably being sturdy and substantially water tight. The lids 4 can be bolted along a flange with fasteners, with a sealing gasket (not shown) between the flange and the lids 4, for water tightness.

Filter media 5 is disposed in tank 3, generally filling to about 75% of the total interior depth. Filtering media 5 can be in direct contact with tank 3 as shown in FIG. 1. Filter media 5 preferably comprises a porous, comparatively light material that rapidly dries. For example, filter media 5 can include lava rock.

A submersible pump 8 rests near, but preferably somewhat above the bottom of tank 3. For example, pump 8 can be positioned approximately 6 inches from the bottom of tank 3. Disposing pump 8 above the bottom of tank 3 allows for treated effluent sludge to collect in the bottom of tank 3, where it can be back washed using back wash 6 and removed, such as on a periodic basis.

Pump 8 is preferably disposed in a pump chamber 9. The pump chamber can be formed from aluminum or a polymer, such as PVC. Pump 8 is preferably isolated from media 5 with a suitable separation structure (not shown) disposed between pump 8 and filter media 5 to prevent filter media 5 from reaching pump 8. For example, filter fabric can be used for this purpose. Filter fabric can also provide added effluent filtering. Filter fabric can be back washed or removed as required, or on a periodic basis.

Pump 8 can receive power from a home a control panel 18 and an electrical conduit 19 shown in FIG. 2. A high water float switch 14 can turn on pump 8 when the level of the fluid in tank 3 rises to a preset level and a low water flow float switch 15 can shut off pump 8 when a preset low level is reached. A high water emergency float switch 16 is preferably located above the filter media 5 to prevent pump activation if fluid accumulates excessively in tank 3, such as due to media “blinding” or due to a malfunction of pump 8.

A float switch 16 referred to as a emergency switch can protect the environment from system 100 discharging partially treated effluent. Emergency switch 16 can also be used to initiate a warning signal, via an alarm box (not shown) coupled to an electric line, that the level in tank 3 is too high.

Output from pump 8 output is supplied through output pipe 55 preferably to flow splitter 13. Flow splitter 13 can divide effluent received from output pipe 55 into a first flow which is directed back onto filter media 5. Flow splitter can be an active or passive device. In one embodiment, flow splitter 13 is a passive device, such as an orifice plate having two outputs, the respective outputs sized to produce a desired flow division.

The first flow is directed back onto filter media 5 through pipe 10. Pipe 10 preferably includes structure for injecting air, such as venturii 11. Venturii 11 inducts air into pipe 10 and supplies air to the fluid flow in pipe 10. The air in pipe 10 causes desirable aeration to the recycling effluent and agitation to the filter media in tank 3.

Liquid supplied by pipe 10 is preferably distributed substantially evenly over the area comprising the top of filter media 5. Spray heads 6 or other suitable devices can be used for this purpose. Thus, the recirculated effluent trickles or splatters down across the area of filter media 5 through spray heads 6, the combined agitation and aeration provided pretreating the effluent before reapplication of the partially filtered effluent to media 5.

A second flow from flow splitter 13 is directed out from tank 3, through pipe 40, such as to a drip irrigation system or a perforated pipe disposed in a bed of rocks. Pipe 40 is buried below the surface, such as by about 6 to 12 inches.

In filter operation, effluent initially trickles or flows onto media 5 from pipe 1 and is filtered by media 5 and cleaned in the process. Filtered effluent eventually causes the fluid level in tank 3 to rise, so that the pump 8 turns on by the float switch 14. Fluid is then pumped up pipe 55 to flow splitter 13. Some of the fluid, such as 2, 4, 5, 6, 8 or 10% exits tank via pipe 10. Generally at least 90%, such as 90, 92, 94, 95, 96 or 98% of the liquid is reapplied to media 5 via pipe 10 and spray heads 6. Thus, the recycling process disclosed repeatedly cleans the effluent, for example from ten to twenty, or fifty times before it is discharged from tank 3.

The fluid level in tank 3 slowly drops during pump operation. Pump 8 eventually turns off once low water float switch 15 is activated. Once sufficient effluent is again supplied to tank 3 via pipe 1 from septic tank 50, pump 8 again turns on and the filtering process again proceeds.

Thus, the invention does not require timers or solenoid valves which generally include expensive or complicated controls. Pump 8 supplies the aeration, the recycling and the disposal for the treatment process performed by system 100. In fact, other than pump 8 and associated float switches 14-16 all other components included in system 100 can be passive. No timer or volume flow measurement structure needs to be supplied to control the recirculation process. The simplicity of system 100 can lower the system cost, reduce maintenance costs, and increase reliability through reduced component failure.

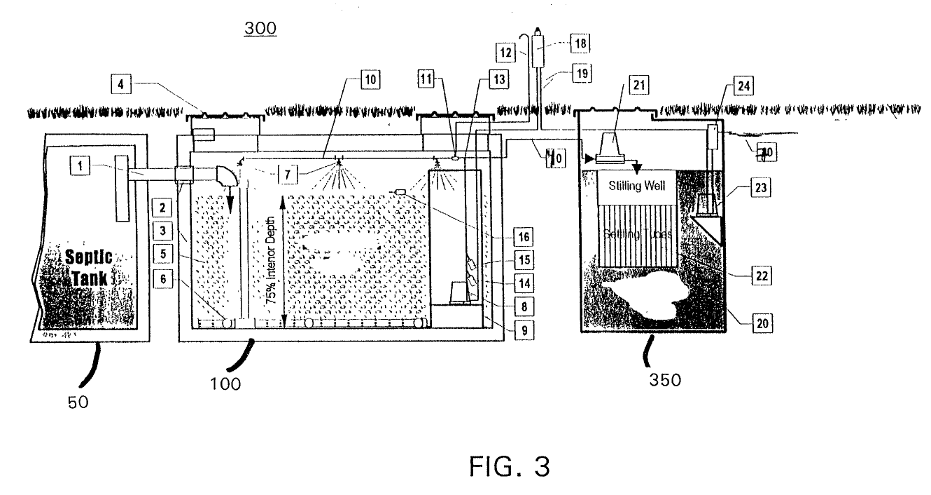

In some applications, it may be desirable to chlorinate the treated effluent output by tank 8. FIG. 3 shows a side view of a filtration system 300 which includes chlorinator 350. Pipe 40 from tank 8 provides filtered effluent to chlorinator 350. Chlorinator may include an optional dechlorinator (e.g. charcoal array) to substantially remove chlorine from the filtered effluent before release into the environment. Dechlorinator will generally only be necessary when high relative levels of chlorine are added by chlorinator 350.

Chlorinator 350 includes chlorine injection system 21 which adds chlorine to the filtered effluent flow prior to providing the same to sitting well/settling tubes 22. Chlorinator 350 can also include drip irrigation pump, float switch and brackets 23, and drip irrigation strainer 24.

It should be understood that the examples and embodiments described herein are for illustrative purposes only and that various modifications or changes in light thereof will be suggested to persons skilled in the art and are to be included within the spirit and purview of this application. The invention can take other specific forms without departing from the spirit or essential attributes thereof.

What is claimed is:

1. A filtration system for processing effluent from septic-based sanitation systems, comprising:
at least one treatment tank, said tank for receiving effluent from a septic tank, said tank including at least one filtering media therein, said filtering media adapted for filtering said effluent to produce filtered effluent, and
structure for recirculating said filtered effluent, wherein a first portion of said filtered effluent is directed back onto said filtering media and a second portion of said filtered effluent is directed out of said tank.

2. The system of claim 1, wherein said first portion is at least 90% of said filtered effluent.

3. The system of claim 1, wherein said first portion is at least 95% of said filtered effluent.

4. The system of claim 1, wherein said structure for recirculating comprises a submersible pump.

5. The system of claim 4, wherein said pump is adapted to shut off when an effluent level is below a first predetermined level in said tank and turned on when said effluent level is above a second predetermined level in said tank.

6. The system of claim 4, wherein said submersible pump is the only active component in said system.

7. The system of claim 4, wherein a bottom of said submersible pump is disposed above a bottom surface of said treatment tank.

8. The system of claim 1, wherein at least one orifice plate is used to divide said filtered effluent into said first and second portions.

9. The system of claim 1, further comprising a drip irrigation system, wherein said drip irrigation system receives said second portion.

10. The system of claim 1, wherein a portion of said filtering media is in contact with said tank.

11. The system of claim 1, further comprising a chlorination tank for chlorinating said second portion.

12. The system of claim 11, further comprising structure for dechlorinating said chlorinated second portion.

13. The system of claim 12, further comprising a drip irrigation system, wherein said drip irrigation system receives said dechlorinated second portion.

14. A method of filtering effluent from septic-based sanitation systems, comprising the steps of:
directing effluent from a septic tank into at least one treatment tank, said treatment tank including at least one filtering media therein, said filtering media adapted for filtering said effluent to produce filtered effluent, and
recirculating at least a portion said filtered effluent, wherein a first portion of said filtered effluent is directed back onto said filtering media and a second portion of said filtered effluent is directed out of said tank.

15. The method of claim 14, wherein said first portion is at least 90% of said filtered effluent.

16. The method of claim 14, wherein said first portion is at least 95% of said filtered effluent.

17. The method of claim 14, wherein a submersible pump is used for said recirculating step.

18. The method of claim 17, further comprising the steps of turning off said pump when an effluent level is below a first predetermined level in said tank and turning on said pump when said effluent level is above a second predetermined level in said tank.

19. The method of claim 14, wherein at least one orifice plate is used to divide said filtered effluent into said first and second portions.

20. The method of claim 14, further comprising the step of distributing said second portion though a drip irrigation system.

21. The method of claim 14, further comprising the step of chlorinating said second portion.

22. The method of claim 21, further comprising the step of dechlorinating said chlorinated second portion.

23. The method of claim 22, further comprising the step of distributing said dechlorinated second portion through a drip irrigation system.
